(19) United States
(12) Patent Application Publication
(10) Pub. No.: US 2018/0340791 A1
(43) Pub. Date: Nov. 29, 2018

(54) Presentation of a Journey Route by Way of a Navigation System

(71) Applicant: Bayerische Motoren Werke Aktiengesellschaft, Muenchen (DE)

(72) Inventor: Wolfgang HAHN, Petershausen (DE)

(21) Appl. No.: 15/977,897

(22) Filed: May 11, 2018

(30) Foreign Application Priority Data
May 24, 2017 (DE) 102017208867.2

(51) Int. Cl. G01C 21/36

(52) U.S. Cl. CPC G01C 21/367; G01C 21/3676

(57) ABSTRACT

A method for presenting a journey route by way of a navigation system, in particular a navigation system of a two-wheeled or four-wheeled motor vehicle, in which a graphical presentation of a digitized map and the course of the journey route already traveled is presented on a display of the navigation system, includes, given an unchanged scale of the presentation with the traveling of sections of the journey route, the sections of the journey route that have already been traveled are fully or partly faded out and further sections of the journey route that are still to be traveled, which were absent in the presentation before sections of the journey route that have already been traveled were faded out, are faded in or presented graphically on the display.

### CROSS REFERENCE TO RELATED APPLICATION

This application claims priority under 35 U.S.C. § 119 from German Patent Application No. DE 10 2017 208 867.2, filed May 24, 2017, the entire disclosure of which is herein expressly incorporated by reference.

### BACKGROUND AND SUMMARY OF THE INVENTION

The invention relates, in particular, to a method for presenting a journey route by way of a navigation system, in particular a navigation system of a two-wheeled or four-wheeled motor vehicle, in which a graphical presentation of a digitized map and the course of the journey route already traveled is presented on a display of the navigation system.

DE 10 2006 054 326 A1 discloses a method for presenting route information for a navigation system, in which a graphical presentation of a digitized map is displayed and the course of a journey route already traveled is highlighted on a display. When traveling on the course, driving speeds are detected and the course traveled is highlighted depending on the respectively determined driving speeds.

In the case of route guidance, the following are displayed on screens of known navigations systems: a map section, the vehicle's own position in the map section, the path (in color) calculated by the navigation system and any additional information such as the traffic situation or the weather. Typical screens or monitors of navigation systems nowadays have an aspect ratio of x:y where x>y, for example an aspect ratio of 4:3 or 16:9. The vehicle's own position is, in this case, displayed independently of the selected presentation type, such as a north-facing presentation, presentation pointing in the direction of travel, centrally near to or at the crossing point of the screen diagonals, including the route to be traveled up to the edge of the screen.

If the vehicle's own position is displayed in the map in or at the center of the map section of the known navigation systems and if one were to move, for example, in the north-south direction, in this presentation, the distance already driven would be approximately the same length as the distance still to be driven. Since the distance already driven is generally less interesting than the distance still to be driven or than the information along the distance still to be driven, the distance still to be driven is underweighted compared to the distance already driven. This disadvantage or underweighting is particularly great when the distance displayed runs parallel to the short side of the monitor of the navigation system.

The object of the invention is, in particular, the provision of an improved method for presenting a journey route by way of a navigation system.

The invention proceeds from a method for presenting a journey route by way of a navigation system, in particular a navigation system of a two-wheeled or four-wheeled motor vehicle, in which a graphical presentation of a digitized map and the course of the journey route already traveled is presented on a display of the navigation system.

There is provision in accordance with the invention for, given an unchanged scale of the presentation with the traveling of sections of the journey route, the sections of the journey route that have already been traveled to be fully or partly faded out and for further sections of the journey route that are still to be traveled, which were absent in the presentation before sections of the journey route that have already been traveled were faded out, to be faded in or presented graphically on the display.

The object of the invention is achieved in a particularly sophisticated manner by the measures according to the invention. By way of presenting the distance still to be traveled in accordance with the invention by extended sections or a longer course section of the journey route, it is possible, within a presentation scale, for relevant information, such as topology of the course guidance and/or upcoming traffic obstructions, to be able to be perceived earlier by the driver. It is then possibly no longer necessary to change to a larger scale at the expense of the detail resolution of the presentation, The driver obtains a better foresight and can adapt to changing peripheral conditions earlier.

### DESCRIPTION OF EMBODIMENTS OF THE INVENTION

In one preferred embodiment of the method according to the invention, there is provision for the number of sections along the journey route that are still to be traveled, the number being presented on the display, to be greater than the presented number of sections along the journey route that have already been traveled, wherein the sections are each of an identical length.

In the route guidance, the ratio of the course driven to the course still to be driven can be weighted in favor of the course to be driven, such as, for example, by a ratio of 2:3 with two parts for the course driven and three parts for the course still to be driven. The vehicle's own position would therefore always be situated in one half of the monitor. In this case, the ratio can be determined from the real travel distances obtained from the digital map and/or from the length of the shorter side of the monitor. If east-west components are also added to the driving direction, the presentation of the vehicle's own position and hence the length ratio of course driven to course still to be driven can be optimized in the x direction and the y direction. The ratio of the courses can in this case be fixedly prescribed, adapted dynamically by the method according to the invention or else set in a selectable manner by the driver.

In accordance with one preferred development of the method according to the invention, there is provision for the ratio of the presented number of sections of the journey route that are still to be traveled to the presented number of sections of the journey route that have already been traveled to be significantly greater than 1, such as, in particular, is a ratio of 3:2 or 4:2 or 5:2.

In one configuration of the method according to the invention, there is provision for, in the case of a journey route in a distinct north-south direction in contrast to a journey route running substantially in the east-west direction, the number of sections along the journey route that are still to be traveled, the number being presented on the display, to be increased in relation to the presented number of sections along the journey route that have already been traveled.

In one preferred embodiment of the method according to the invention, there is provision for the display to be selected in such a way that the display has a greater presentation width than presentation height, such as, in particular, an aspect ratio of 4:3 or 16:9.

The invention also makes it possible to provide a navigation system, in particular of a two-wheeled or four-wheeled motor vehicle, in which the navigation system executes a method according to the invention.

The invention furthermore makes it possible to provide a motor vehicle having a navigation system, in particular a two-wheeled or four-wheeled motor vehicle, in which the navigation system executes a method according to the invention.

Finally, the invention makes possible a computer program product for controlling at least one processor, in particular a processor of the navigation system according to the invention, the processor effecting the execution of at least one step of a method according to the invention.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for presenting a journey route by way of a navigation system, comprising the acts of:
a) presenting a graphical presentation of a digitized map and a course of the journey route on a display of the navigation system; and
b) wherein, given an unchanged scale of the graphical presentation with traveling of sections of the journey route, fully or partly fading out first sections of the journey route that have already been traveled from the display, and fading in or presenting graphically on the display second sections of the journey route that are still to be traveled, which second sections were absent in the graphical presentation before the first sections were fully or partly faded out.

2. The method as claimed in claim 1, wherein the navigation system is in a two-wheeled or four-wheeled motor vehicle.

3. The method as claimed in claim 1, wherein a number of the second sections on the display is greater than a number of the first sections on the display and wherein the first sections and the second sections have an identical length.

4. The method as claimed in claim 3, wherein a ratio of the number of the second sections to the number of the first sections is significantly greater than 1.

5. The method as claimed in claim 4, wherein the ratio is 3:2, 4:2, or 5:2.

6. The method as claimed in claim 1, wherein the journey route is in a north-south direction and wherein a number of the second sections on the display is increased in relation to a number of the first sections on the display.

7. The method as claimed in claim 6, wherein the display has a greater presentation width than a presentation height.

8. The method as claimed in claim 7, wherein a ratio of the presentation width to the presentation height is 4:3 or 16:9.

9. A navigation system, wherein the navigation system executes the method as claimed in claim 1.

10. The navigation system as claimed in claim 9, wherein the navigation system is in a two-wheeled or four-wheeled motor vehicle.

11. A motor vehicle, comprising:
a navigation system, wherein the navigation system executes the method as claimed in claim 1.

12. The motor vehicle as claimed in claim 11, wherein the motor vehicle is a two-wheeled or four-wheeled motor vehicle.
